(19) United States
(12) Patent Application Publication
(10) Pub. No.: US 2018/0162593 A1
(43) Pub. Date: Jun. 14, 2018

(54) Collapsible Container for Connection to Child Safety Cover

(71) Applicant: Stuart HERSKOVITZ, Dix Hills, NY (US)

(72) Inventor: Stuart HERSKOVITZ, Dix Hills, NY (US)

(21) Appl. No.: 15/376,081

(22) Filed: Dec. 12, 2016

(51) Int. Cl. B65D 21/08; B65D 50/04; A61J 1/03; B65D 41/04

(52) U.S. Cl. CPC B65D 21/086; B65D 41/04; A61J 1/03; B65D 50/043

(57) ABSTRACT

A collapsible container includes: a container bottom; and a tubular member having a longitudinal axis and a cylindrical wall. The tubular member has an outer surface and an inner surface. The cylindrical wall has a thickness defined by the distance between the inner and outer surfaces, the cylindrical wall having two longitudinal zones of reduced thickness. The two longitudinal zones are substantially 180° apart such that the tubular member is collapsible along the two longitudinal zones to reduce the tubular member to a flattened state, the tubular member having a first end adapted to receive the container bottom, a second end being adapted to selectably mate with a child-resistant container cap. The container bottom is integrally formed with the tubular member and the second end has integral edge structures formed thereon that are configured to cooperate with and engage structures of the child-resistant container cap to effect child-resistant opening protection.

### BACKGROUND OF THE INVENTION

### 1. Field of the Invention

The present invention is directed to collapsible containers, such as pill containers for dispensing of medicine.

### 2. Discussion of Related Art

Containers, such as pill containers, are known. A typical pill container has a rigid tubular shaped main body, with an integrally formed bottom surface and an opening at the top that may have, for example, structure formed at the upper edge configured to allow a separate cover or cap to be screwed or snapped onto the top of the rigid tubular main body.

A variation is shown in U.S. Pat. No. 5,180,072, which is incorporated herein by reference in its entirety, in which the rigid tubular body, with the integrally formed bottom, has an integrally formed cap that is attached to the tubular body by webs connecting a portion of the upper edge of the tubular body to a cap or closure. In this variation, the cap is provided with child-resistant structures that make it difficult for a child to obtain access to the contents of the container when the container is in the closed position.

A drawback of the container discussed above is that, due to the rigid structure of the tubular body, the containers when empty take up a considerable amount of space, for example, if stored on shelf or in a drawer. Pharmacies must keep a large number of empty containers of this type on hand for dispensing medicine in the form of pills, capsules or cream. Because of the rigidity of the tubular body, much of the space required to store such containers actually consists of the empty space within the body of the tubular portion. This drawback is overcome by the present invention discussed below.

### SUMMARY OF THE INVENTION

The present invention solves the above-mentioned problems of the prior art by providing a collapsible container with a resilient tubular member, having inner and outer surfaces and a defined wall thickness, the wall of the tubular member having first and second longitudinal zones of reduced thickness allowing the tubular member to be collapsed into a flattened state for packaging and storage. A bottom portion is, according to a preferred embodiment, attached to and integrally formed with the resilient tubular member, for example by injection or other molding techniques. Connecting structure is, according to a preferred embodiment, formed at the top side of the tubular member, the connecting structure being shaped and dimensioned to be compatible with a known child resistant cap structure.

According to a first aspect of the present invention, a collapsible container includes: a container bottom movable between a first position and a second position; and a tubular member having a longitudinal axis and a cylindrical wall, the tubular member being connected to the container bottom and having an outer surface and an inner surface, the cylindrical wall having a wall thickness defined by the distance between the inner and outer surfaces, the cylindrical wall having first and second longitudinal zones of reduced thickness, the first and second longitudinal zones being substantially 180° apart such that the tubular member is collapsible along the first and second longitudinal zones to reduce the tubular member to a flattened state, the tubular member having a first end adapted to receive the container bottom when the container bottom is in the second position, a second end being adapted to selectably mate with a child-resistant container cap. The container bottom is integrally formed with the tubular member and wherein the second end has integral edge structures configured to cooperate with and engage structures of the child-resistant container cap to effect child-resistant opening protection.

In another aspect, the tubular member is connected to the container bottom by an integrally formed container bottom web.

In another aspect, the container bottom web attaches to the tubular member so as to be inserted into a longitudinal end of the tubular member.

In another aspect, the tubular member is composed of a plastic material from the group consisting of polyethylene, polypropylene, polyvinylchloride and nylon.

In another aspect, the container bottom and tubular member are integrally formed in relation to one another by injection molding.

In another aspect, the first and second longitudinal zones have a reduced thickness of from 20 to 80% of the wall thickness.

In another aspect, the first and second longitudinal zones are about 50% of the thickness of the cylindrical wall thickness.

In another aspect, the integral edge structures at the second end comprise threading.

In another aspect, the integral edge structures at the second end comprise lugs configured to twistingly securely engage with corresponding structures in the child-resistant container cap.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. In the drawings:

FIG. 1 is a perspective view of a collapsible container in accordance with one embodiment of the present invention;

FIG. 2A is a cross sectional view of the collapsible container of FIG. 1 taken along line 2—2 of FIG. 1;

FIG. 2B is an end view of the top of the collapsible container of FIG. 1 showing structures for connecting the container to a child safety cover;

FIG. 3 is a perspective view of the collapsible container in a collapsed condition;

FIG. 4 is a cross sectional view taken along line 4—4 of FIG. 3;

FIG. 5 is a perspective view of the collapsible container with the bottom attached in accordance with one embodiment of the present invention, also showing a compatible child safety cover for use therewith;

FIG. 6 is a side elevation with the cylindrical body, and the child safety cover shown in FIG. 5 in a partial cross-sectional view;

FIG. 7 is an exploded view showing the collapsible container with the bottom attached in accordance with an embodiment of the present invention, also showing a compatible child safety cover; and

FIG. 8 is a perspective view of the collapsible container with the bottom attached in accordance with an embodiment of the present invention, also showing another compatible child safety cover.

### DETAILED DESCRIPTION OF THE PRESENTLY PREFERRED EMBODIMENTS

Referring to FIG. 1, a collapsible container 1 has a cylindrical body 2 with an outer surface 3 and an inner surface 4 and defining an inner space 35. The body has a wall thickness defined by the distance between the inner and outer surfaces. The body (tube) 2 has a first end 5, or bottom, which is adapted to be sealingly closed by a bottom cover 30, shown partially in FIG. 1.

Preferably, the first end 5 fits snugly within the bottom cover 30 to provide an airtight fit, for sealing the bottom, for example, of a pill container. To maintain a tight fit, it is advantageous to assure that there is sufficient overlap between the walls 31 of the bottom cover 30 and first end 5 to provide an interference fit for retaining the body (tube) 2 in a cylindrical shape substantially across its length. When the bottom cover 30 is so affixed, rigidity is provided to the body 2.

Preferably, to increase the strength of the assembled pill container, a portion of the bottom cover is configured to be received within the bottom of the tube body 2.

Preferably, as a result of forming the body 2 and the bottom cover 30 integrally, for example by molding, the first end 5 is connected to the bottom cover 30 by a bottom cover web 33. This web 33 serves to connect the body 2 to the bottom cover 30 to allow for storage of the body 2, typically in a flattened state, and the bottom cover 30 without having these components separate from each other.

The cylindrical body 2 has a cap end 8, configured to, in an un-collapsed state of the cylindrical body 2, sealingly engage a child proof safety cover (or cap). Such a cap, not shown in FIG. 1, has internal structures that allow for a child-proof attachment of the cap to the cap end 8 of the cylindrical body 2, for example by preventing opening of the cap until, as the case may be, certain portions of the edge of the cap are squeezed simultaneously, until the cap has been sufficiently pressed downwardly, or until and downward and twisting motion of the cap has been initiated.

As will be described in more detail below, the upper edge of the cylindrical body 2 has corresponding structure to engage child-proofing structure for a child proof safety cover, in a closed state. For example, as shown in the example of FIG. 1, an apron 40 is formed at the periphery of the cap end 8 (i.e., the open top end) of the cylindrical body 2, the apron 40 having a plurality of lugs 42 proximate the open end. In this embodiment, the lugs 42 are preferably of a type that is compatible with retaining structures formed in the cap shown in U.S. Pat. No. 5,938,055. In this patent, the cap is secured by first pressing the cap down, and then twisting the cap to engage the retaining structures of the cap with the lugs 42. This embodiment will be discussed further below. However, the invention is not limited to providing this particular structure at the cap end 8 of the cylindrical body 2. As will be seen below, the present invention envisions cap end structures that can be formed so as to engage different child proof safety closures.

Preferably, the tube 2 and the bottom end 30 are each formed of a plastic material such as polyethylene, polypropylene, nylon, polyvinylchloride or other material suitable for use in a molding process. Some composite materials such as a fiberboard/plastic hybrid material may also be used with the present invention.

The cylindrical body 2 has a pair of longitudinal grooves 9 and 10 located at approximately 180° apart. These grooves extend along substantially the entire length of the interior surface of the cylindrical body 2. Preferably, the grooves extend into the wall thickness of the cylindrical body from 10-80% and preferably from 30-65%. Such an extension into the wall thickness assures that the collapsible container may collapse into a flattened form across these weakening structures i.e., the grooves in the side wall, such that the collapsible container may be packaged in substantially flat form.

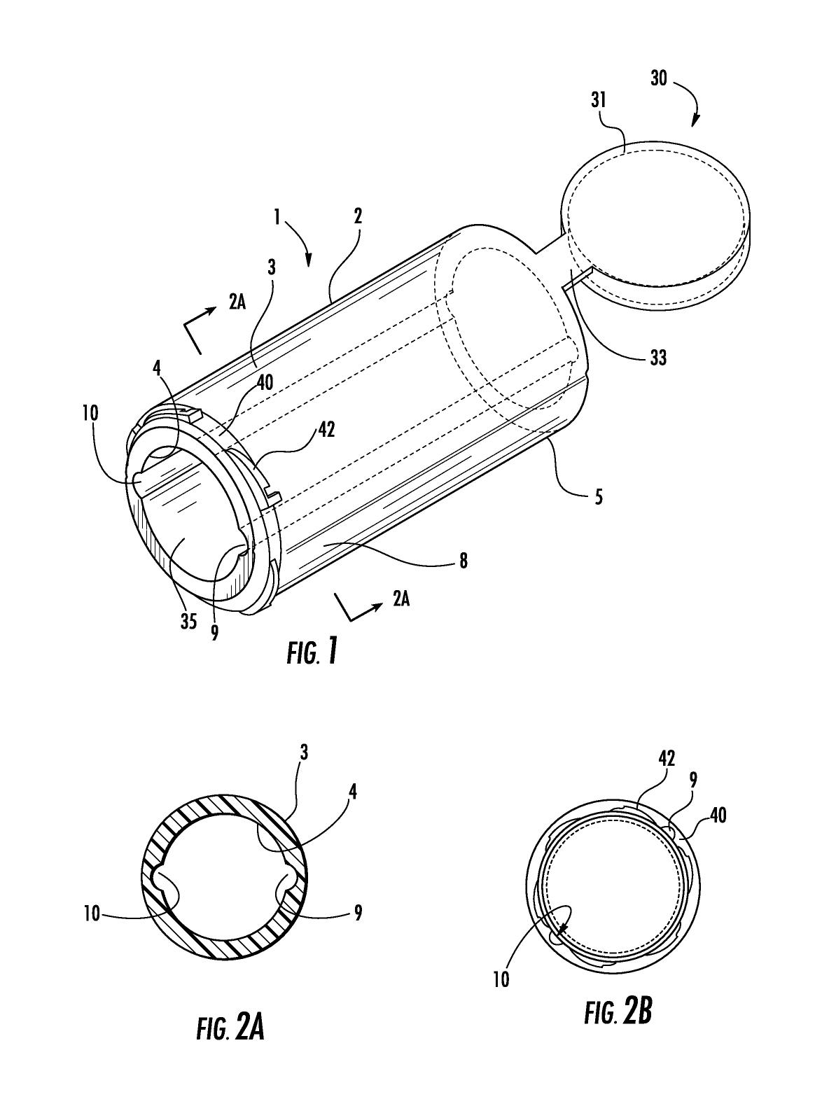

Referring to FIG. 2A, a cross sectional view of the cylindrical body 2 of FIG. 1 is shown in an expanded state with the grooves entering approximately 50% of the wall thickness. For example, a cylindrical body 2 having an outer diameter of approximately 1″ and an inner diameter of approximately ¾″ has a wall thickness of ⅛″. The grooves 9 and 10 preferably have a hemispherical shape and at a center axis of the hemispherical grooves, the depth is about ⅛″. Each groove has a width at the inner tube surface of about 3/16″. While such hemispherical grooves are shown, it will be understood that square or triangular grooves could additionally be used and the shape of the grooves is unimportant so long as a pair of weakening zones are created on opposite sides of the mouthpiece, preferably at 180° to each other, such that the cylindrical tube 2 is collapsible into a flat form.

Utilizing the inventive collapsible container, individual packaging in flat form is facilitated.

FIG. 2B is a view showing the open top end of the cylindrical tube 2. In FIG. 2B, the apron 40 and plurality of lugs 42 are visible.

FIG. 3 illustrates the collapsible container 1 in its collapsed form, in which it is suitable for storage. As shown in the figure, a pair of grooves 12 and 13 are present. The lugs 42 are visible at the flattened open end. The addition of packing, such as shrink wrap to maintain the flattened profile (not shown), allows a plurality of individually packaged collapsible containers to be placed in a box with minimum open space. Additionally, for disposal, the container is easily compressed during disposal into its flat form to minimize the volume it occupies during disposal.

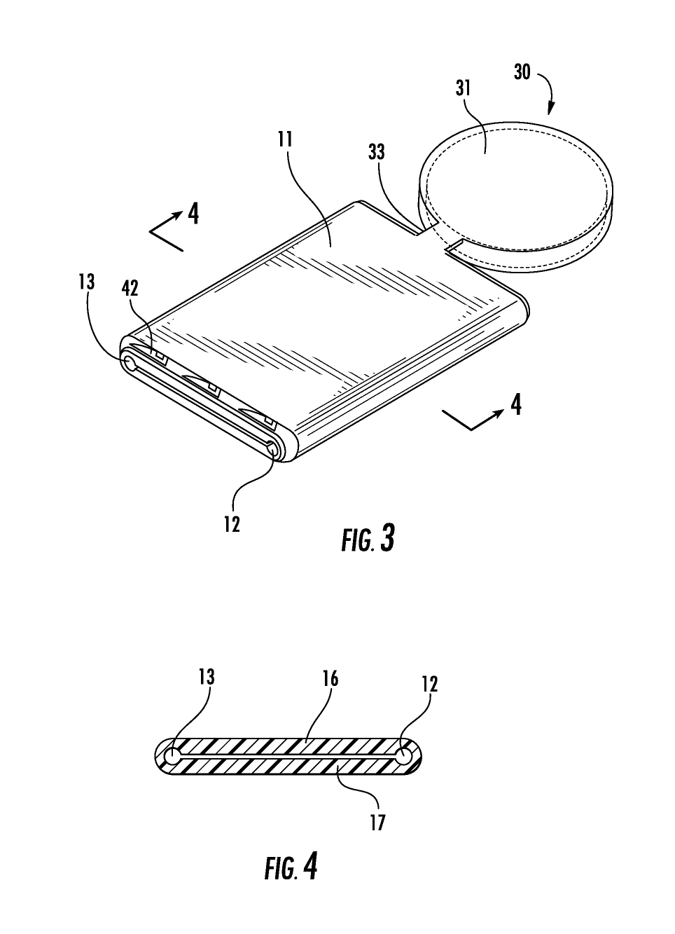

FIG. 4, shows a cross-section taken along the lines 4-4 from FIG. 3. In compressed tube 11, the grooves, being weakening structures, adapt by relieving the compressive force and allowing the tube to collapse into a pair of substantially parallel walls, 16 and 17.

Utilizing the inventive collapsible container simplifies packaging for efficient storage utilization.

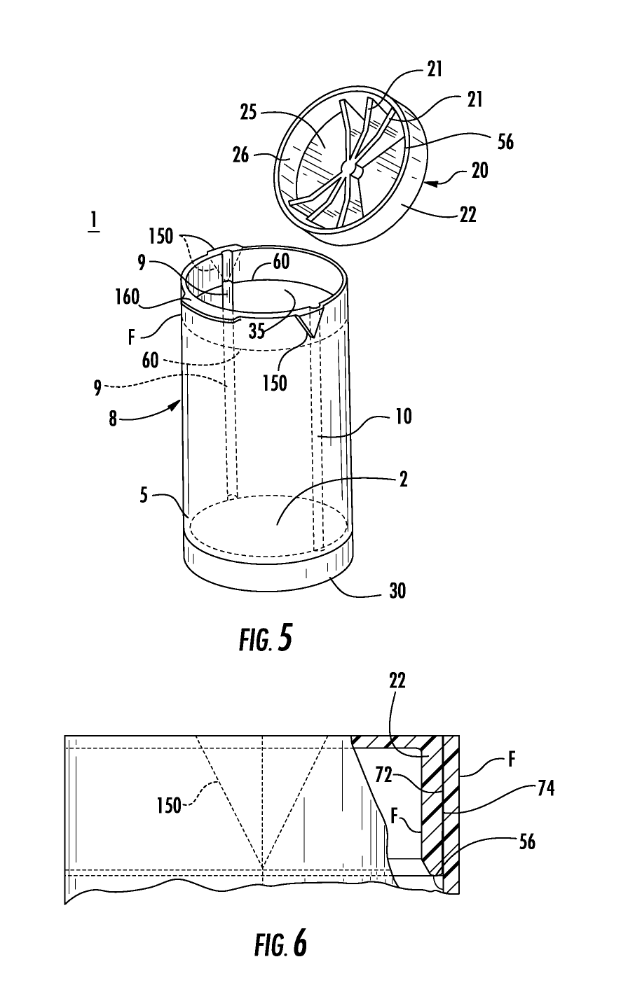

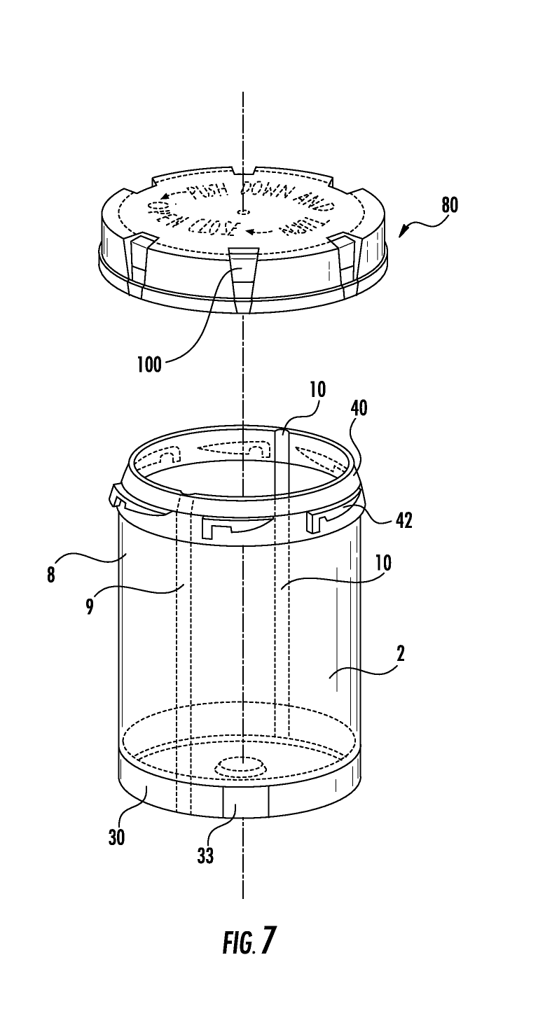

As discussed above, the cap end 8 of the cylindrical tube 2 of the collapsible container 1 can be formed to cooperate with a number of different child-resistant caps. For example, as shown in FIG. 5, a known safety cap of the type shown in U.S. Pat. No. 5,180,072, the contents of which are incorporated herein by reference, can be advantageously used to form the cap 20 of the collapsible container 1.

As shown in FIG. 5, the cap has a downwardly protruding cap wall 22. Side wall 2 and the cap wall 22 define a pair of flexors F. In the system 10 of FIG. 5, the side wall 2 defines an outer flexor disposed outwardly of an inner flexor, which is the cap wall 22.

As shown in FIG. 6, a latch 56 protrudes from the lower outer side of the cap wall 22 and is at least partly receivable in a catch or circular recess on the inner side of the side wall 2 for cooperatively interlocking for normally holding the cap 20 onto the container 1.

In FIG. 6, the flexors F each have thereon an inclined surface, 72 or 74. A frustro-conical first inclined surface 74 facing outward is on the cap wall 22 with its lesser diametered portion at its inner or bottom end, a frustro-conical second inclined surface 72, facing inward, with its lesser diametered portion at its top or outer end on the inner side of the side wall 24. The inclined surfaces 72 and 74 are so cooperatively shaped that when sufficient pressure is applied to two opposite sides, such as the right and left sides of the outer flexor, which is the side wall 2, latch 56 will be forced out of the catch 60 accomplishing opening of container 1.

The required pressure for a medicine vial is the amount of pressure that an average adult person with average strength, or any normal adult person, is capable of applying by the pinching of the outer flexor, which is the container 1 on opposite sides. In the embodiment of FIG. 5, the right side and left side are compressed between the thumb and a finger of the same hand.

Returning to FIG. 5, the cap 20 has a central portion 25 substantially surrounded by the cap wall 22, having an inner surface 26. An optional elongated rib assembly 21 on the underside of the central portion 25 is of one piece with the central portion 25 (or top wall) and provides structural integrity of the cap 20.

The ribs 21 are close enough to the cap wall 22 to substantially block latch-and-catch-unlocking inward movement of the cap wall 22 at the back and front sides of the tube 2 at the cap-side opening so as to deter a child from opening it and accessing the contents.

The flexors F are sufficiently flexible and so-shaped that a force can be applied by substantially any normal adults, against the system 10 sufficiently for assisting the adult to gain access to the cavity 35. The force applied is a pinching of the side wall 24 on its left and right sides about one quarter inch from the top of the tube 2 and at the level of the cap wall 22.

The entire cap 20 is disposed substantially within the outlines of the tube 2 to increase difficulty of gripping the cap 20 and for child safety.

The inward-bending of the outer flexor F is at a point below the upper end of the tube 2 and sufficient force of pinching on the right and left sides of the container at such a position can cause a closure to be expelled. However the amount of force that a small child can apply in such positions is not sufficient to cause opening.

It has been found that if the child squeezes the cap 20, it is usually with a full hand force on all sides, not a pinch, and opening does not occur.

Distractors 150 formed at the cap side opening of the tube 2 also serve as indicators to an adult of where to push and so are made in downwardly pointed triangular arrowhead shape. Horizontally protruding distraction lip 160, which cannot effect opening, is attached to the forward side of the container 1.

FIG. 7 is an exploded viewing showing the tube 2 of the present invention in an expanded state and a child resistant cap 80 as shown in U.S. Pat. No. 5,938,055, discussed above. As was shown above in FIG. 1, the top rim of the tube 2 in this embodiment is dimensioned and shaped so as to be compatible with a cap 80 having retaining structures 100 spaced around the periphery of the cap. The upper edge of the cylindrical body 2 has corresponding structure to provide child-proofing structure for the cap, in a closed state. For example, an apron 40 is formed at the periphery of the open end (top end) of the cylindrical body 2, the apron 40 having a plurality of lugs 42 proximate the open end.

In this embodiment, the lugs 42 are preferably of a type that is compatible with retaining structures 100 formed in the cap 80. The cap is secured by first pressing the cap down, and then twisting the cap to engage the retaining structures 100 of the cap 80 with the lugs 42 of the tube 2.

Note that in this example, the lugs 42 have to be somewhat modified to account for the longitudinal grooves 9 and 10, which must be directly across from one another to allow for a flat collapsing of the tube 2. Since the retaining structures 100 in this cap design do not have an open space between the retaining structures 100 that is directly across from another open space, the lugs 42 corresponding to one of the longitudinal grooves 9 and 10 will have to modified to permit flattening of the tube 2. This can be done by either cutting a slit in one of the lugs 42, or by omitting one of the lugs altogether.

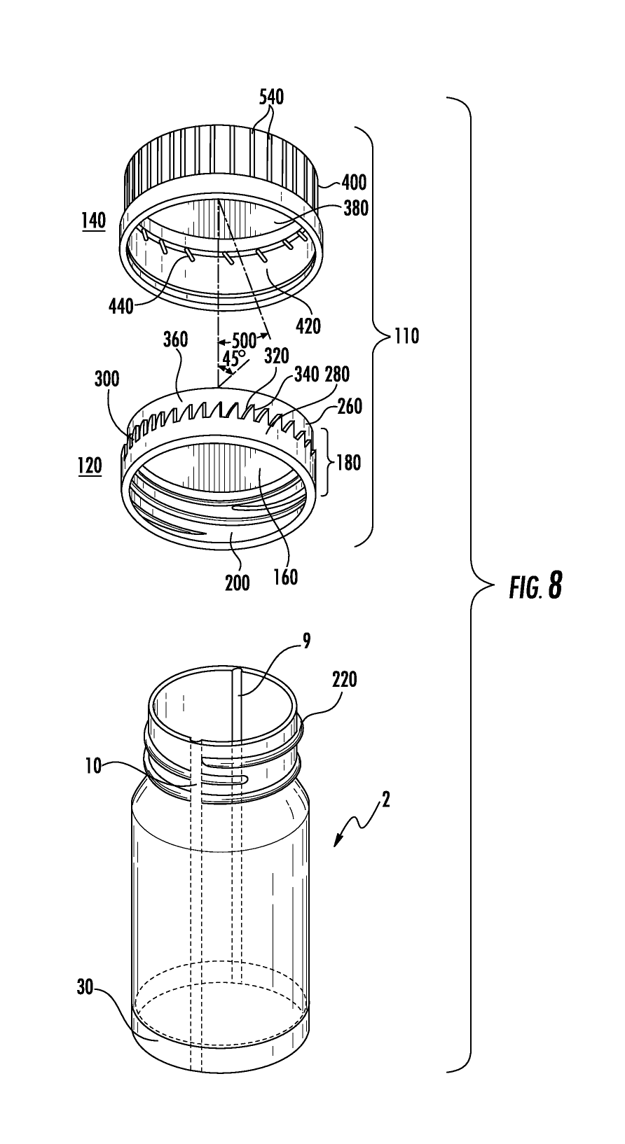

FIG. 8 is an exploded view utilizing the safety cap of U.S. Pat. No. 5,370,251, the contents of which are incorporated herein in their entirety. As can be seen in the figure, a child-resistant closure 110 is constructed and arranged in accordance with the invention. Closure 110 includes an inner cap 120 and an outer cap 140 which are in axial alignment and in close confronting relation with each other. The inner cap 120 has a circular top wall portion 160 and a cylindrical skirt 180 depending from the top wall portion 160. The inner surface of the skirt 200, as shown in FIG. 8, is threaded for threaded engagement with a conventional threaded portion 220 of a tube 2 when the inner cap 120 is rotated in a closing direction, here shown by way of example to be clockwise. The inner cap 120 is disengageable from the threaded portion 220 of the tube 2 when rotated in an opening direction, here, e.g., counterclockwise. The outer surface 26 of the cylindrical skirt of the inner cap 120 is provided with a radial shoulder 280 spaced dependingly downward from the circular top wall portion 160 and extending outwardly from skirt 180.

The radial shoulder 280 has a plurality of angular extending triangular saw toothed projections 300, each projection having a sloped first surface 320 and a substantially vertical second surface 340. The sloped first surface 320 and the substantially vertical second surface 340 define therebetween an angle ranging from about 30° to about 60°, which is contemplated as most typically being about 45°. The plurality of saw toothed projections comprises individual triangular teeth 360.

The outer cap 140 has a circular top wall portion 380 and a cylindrical skirt 400 coaxial with and peripherally surrounding the cylindrical skirt portion 180 of the inner cap 120. The inner surface 420 of the skirt 400 of the outer cap 140 has a plurality of angularly extending knurlings 440 comprising individual drive knurls.

The angularly extending knurlings 440 are complementary to and angled the same way as the angularly extended triangular saw toothed projections 300 located on the radial shoulder 280 of the inner cap 120. Indeed, similar to the angle defined by surfaces 320 and 340 of projections 300, the angle defined between the knurlings 440 and a vertical axis defined by the outer cap 140 is in the range of about 30° to about 60°. When the outer cap 140 is rotated in the opening direction, the knurlings 440 will ratchet or ride up over the vertical second surface of the saw toothed projections 300, thereby preventing rotation of the inner cap 120. This can be overcome only by the simultaneous application of a turning force and an axial force on the outer cap 140 toward the inner cap 120 to enable the outer cap 140 to impart rotation to the inner cap 120 so that the two rotate in unison.

The outer cap 140 further comprises, distal to the circular top 380, an inwardly extending lip portion 50 on the inner surface 420 of skirt 400 for retaining the inner cap 120 and for permitting the inner cap 120 and the outer cap 140 to be in close confronting relation to each other. The outer cap 140 also comprises a plurality of substantially vertical grooves 540 positioned on skirt 400 of outer cap 140 for gripping the outer cap 140.

In order to utilize the child-resistant closure in accordance with the invention and referring to FIG. 8, the closure 110 is first placed on the threaded portion 220 of the tube 2. A rotative force is used to turn the outer cap 140 in the closing, i.e., clockwise direction. The complementary knurlings 440 and saw tooth projections 300 on the outer and inner caps 140, 120 cause the inner cap 120 to remain stationary relative to the outer cap 140. Thus, as the user closes the container, the rotative force provides a seal between the threaded portion 220 of the tube 2 and the threaded portion 200 of inner cap 120.

In order to open the sealed tube 2, the user must utilize both a rotative and an axial force. It is the axial force that prevents the knurlings 440 of the outer cap from ratcheting of riding up over the saw toothed projections 300 of the inner cap. Thus, when the outer cap 140 is rotated in an opening, here counterclockwise, direction, with the use of both rotational and axial force, the knurlings 440 of the outer cap 140 cam with the substantially vertical second surface 340 of the saw toothed projections 300 of the inner cap, thus engaging the caps 140, 120 so that they rotate in unison. This allows the threaded portion 200 of the inner cap 120 to disengage from the threaded portion 220 of the tube 2. Accordingly, the closure 110 is disengaged from the tube 2.

While preferred embodiments of the present invention have been shown and described, it will be understood by those skilled in the art that various changes and modifications could be made without varying from the scope of the present invention.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A collapsible container comprising:
a container bottom movable between a first position and a second position; and
a tubular member having a longitudinal axis and a cylindrical wall, the tubular member being connected to the container bottom and having an outer surface and an inner surface, the cylindrical wall having a wall thickness defined by the distance between the inner and outer surfaces, said cylindrical wall having first and second longitudinal zones of reduced thickness,
said first and second longitudinal zones being substantially 180° apart such that the tubular member is collapsible along the first and second longitudinal zones to reduce the tubular member to a flattened state, the tubular member having a first end adapted to receive the container bottom when the container bottom is in the second position, a second end being adapted to selectably mate with a child-resistant container cap,
wherein the container bottom is integrally formed with the tubular member and wherein the second end has integral edge structures configured to cooperate with and engage structures of the child-resistant container cap to effect child-resistant opening protection.

2. The collapsible container according to claim 1, wherein the tubular member is connected to the container bottom by an integrally formed container bottom web.

3. The collapsible container according to claim 2, wherein the container bottom web attaches to the tubular member so as to be inserted into a longitudinal end of the tubular member.

4. The collapsible container according to claim 1, wherein the tubular member is composed of a plastic material from the group consisting of polyethylene, polypropylene, polyvinylchloride and nylon.

5. The collapsible container according to claim 2, wherein the container bottom and tubular member are integrally formed in relation to one another by injection molding.

6. The collapsible container according to claim 1, wherein the first and second longitudinal zones have a reduced thickness of from 20 to 80% of the wall thickness.

7. The collapsible container according to claim 1, wherein the first and second longitudinal zones are about 50% of the thickness of the cylindrical wall thickness.

8. The collapsible container according to claim 1, wherein the integral edge structures at the second end comprise threading.

9. The collapsible container according to claim 1, wherein the integral edge structures at the second end comprise lugs configured to twistingly securely engage with corresponding structures in the child-resistant container cap.
